(19) United States
(12) Patent Application Publication
(10) Pub. No.: US 2021/0134317 A1
(43) Pub. Date: May 6, 2021

(54) AUTHORITY VEHICLE DETECTION

(71) Applicant: Pony Al Inc., Grand Cayman (KY)

(72) Inventors: Robert Dingli, Cupertino, CA (US); Peter G. Diehl, Shanghai (CN); Chen Yue Li, San Francisco, CA (US)

(21) Appl. No.: 16/671,041

(22) Filed: Oct. 31, 2019

(51) Int. Cl. G10L 25/51; H04R 3/04

(52) U.S. Cl. CPC G10L 25/51; H04R 3/04

(57) ABSTRACT

Described herein are systems, methods, and non-transitory computer readable media for detecting the presence of an authority vehicle in proximity to a vehicle such as an autonomous vehicle and initiating an automated response. Presence of an authority vehicle can be determined based on an analysis of an audio signal stream received from an audio capture device, such as a microphone, present in the vehicle. Various audio signals representative of sounds other than an authority vehicle siren can be filtered from the audio signal stream to produce a filtered output. The filtered output can then be analyzed to determine whether it contains an audio signal indicative of the presence of an authority vehicle. Such a determination can be made by assessing characteristics of the audio signal such as intensity, frequency, and/or periodicity. If an authority vehicle is present, various response measures can be taken such as initiating an automated braking operation.

The present invention relates generally to automated detection of the presence of an authority vehicle, and more particularly, in some embodiments, to automated detection of the presence of an authority vehicle in proximity to a vehicle based on an analysis of audio signals captured by audio capture devices provided in the vehicle.

### BACKGROUND

A vehicle, such as an autonomous vehicle (AV), includes a myriad of sensors that provide continuous streams of sensor data captured from the vehicle's surrounding environment. Such sensor data enables an AV to perform a number of functions that would typically be performed, at least in part, by a manual human operator including various vehicle navigation tasks such as vehicle acceleration and deceleration, vehicle braking, vehicle lane changing, adaptive cruise control, blind spot detection, rear-end radar for collision warning or collision avoidance, park assisting, cross-traffic monitoring, emergency braking, and automated distance control.

Certain on-board vehicle sensors provide sensor data that bolsters a vehicle's field-of-view such as cameras, light detection and ranging (LiDAR)-based systems, radar-based systems, Global Positioning System (GPS) systems, sonar-based sensors, ultrasonic sensors, accelerometers, gyroscopes, magnetometers, inertial measurement units (IMUs), and far infrared (FIR) sensors. Real-time spatial information can be determined from sensor data captured by such on-board sensors located throughout the vehicle, which may then be processed to calculate various vehicle parameters and determine safe driving operations of the vehicle.

While an AV can include a variety of on-board sensors for enhancing the vehicle's field-of-view, autonomous vehicle technology suffers from various technical drawbacks relating to detecting and utilizing audio characteristics of a vehicle's surrounding environment to aid in the vehicle's operations. Described herein are technical solutions that address at least some of these drawbacks.

### SUMMARY

Described herein are systems, methods, and non-transitory computer readable media for detecting the presence of an authority vehicle in proximity to a vehicle and initiating an automated response thereto. In example embodiments, presence of an authority vehicle in proximity to a vehicle such as an autonomous vehicle is determined based on an analysis of an audio signal stream received from an audio capture device, such as a microphone, present in the vehicle.

In an example embodiment of the invention, a method for automated detection of an authority vehicle includes receiving an audio signal stream from an audio capture device associated with a vehicle, identifying an audio signature present in the audio signal stream as a known audio signature, and filtering out an audio signal corresponding to the known audio signature from the audio signal stream to obtain a filtered audio signal stream output. The method further includes determining that the filtered audio signal stream output is indicative of presence of the authority vehicle in proximity to the vehicle and initiating a vehicle response measure.

In another example embodiment of the invention, a system for automated detection of an authority vehicle includes at least one processor and at least one memory storing computer-executable instructions. The at least one processor is configured to access the at least one memory and execute the computer-executable instructions to perform a series of operations. In an example embodiment, the series of operations includes receiving an audio signal stream from an audio capture device associated with a vehicle, identifying an audio signature present in the audio signal stream as a known audio signature, and filtering out an audio signal corresponding to the known audio signature from the audio signal stream to obtain a filtered audio signal stream output. The series of operations further includes determining that the filtered audio signal stream output is indicative of presence of the authority vehicle in proximity to the vehicle and initiating a vehicle response measure.

In another example embodiment of the invention, a computer program product for automated detection of an authority vehicle is disclosed. The computer program product includes a non-transitory computer-readable medium readable by a processing circuit, where the non-transitory computer-readable medium stores instructions executable by the processing circuit to cause a method to be performed. In an example embodiment, the method includes receiving an audio signal stream from an audio capture device associated with a vehicle, identifying an audio signature present in the audio signal stream as a known audio signature, and filtering out an audio signal corresponding to the known audio signature from the audio signal stream to obtain a filtered audio signal stream output. The method further includes determining that the filtered audio signal stream output is indicative of presence of the authority vehicle in proximity to the vehicle and initiating a vehicle response measure.

Example embodiments of the invention include the following additional features and aspects that can be implemented in connection with the above-described method, system, and/or computer program product. In an example embodiment, identifying the audio signature present in the audio signal stream as a known audio signature includes determining that the audio signature matches one of a set of stored known audio signatures. In an example embodiment, identifying the known audio signature that matches the audio signature present in the audio signal stream includes analyzing another audio signal stream received from the audio capture device prior to audio signal stream and extracting the known audio signature from the prior received audio signal stream.

In an example embodiment, the audio signal corresponding to the known audio signature is a first audio signal, and a second audio signal in the audio signal stream is determined to be below a threshold sound intensity value for a threshold period of time. Based on this determination, the second audio signal can be filtered from the audio signal stream to further obtain the filtered audio signal stream output.

In an example embodiment, a third audio signal in the audio signal stream can be determined to be above the threshold sound intensity value for less than a threshold period of time and can be filtered from the audio signal stream to further obtain the filtered audio signal stream output.

In an example embodiment, determining that the filtered audio signal stream output is indicative of presence of the authority vehicle in proximity to the vehicle includes determining that the filtered audio signal stream output includes an audio signal that is above a threshold sound intensity value for at least a threshold period of time, determining that a frequency of the audio signal is within a predetermined range of frequencies for at least the threshold period of time, and determining that a periodicity of the audio signal is within a predetermined range of periodicities for at least the threshold period of time.

In an example embodiment, initiating the vehicle response measure includes initiating an automated braking operation to bring the vehicle to a halt at least a predetermined distance from a travel path of the authority vehicle.

In an example embodiment, the audio capture device is a microphone located within an interior of the vehicle and/or the vehicle is an autonomous vehicle.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 is a schematic block diagram illustrating an example configuration of on-board vehicle components configured to implement automated authority vehicle detection in accordance with an example embodiment of the invention.

FIG. 2 is a schematic hybrid data flow and block diagram illustrating automated authority vehicle detection in accordance with an example embodiment of the invention.

FIG. 3 illustrates various audio signals that may be present in an audio signal stream received from an audio capture device in accordance with an example embodiment of the invention.

FIG. 4 is a process flow diagram of an illustrative method for automated authority vehicle detection in accordance with an example embodiment of the invention.

FIG. 5 is a schematic block diagram illustrating an example networked architecture configured to implement example embodiments of the invention.

### DETAILED DESCRIPTION

In the following description, certain specific details are set forth in order to provide a thorough understanding of various embodiments of the invention. However, one skilled in the art will understand that the invention may be practiced without these details. Moreover, while various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

A claimed solution rooted in computer technology overcomes problems specifically arising in the realm of computer technology. Described herein are systems, methods, and non-transitory computer readable media that provide technical solutions rooted in computer technology for detecting the presence of an authority vehicle in proximity to a vehicle and initiating an automated response thereto. In example embodiments, presence of an authority vehicle in proximity to a vehicle such as an autonomous vehicle is determined based on an analysis of an audio signal stream received from an audio capture device, such as a microphone, present in the vehicle. An authority vehicle may include any vehicle (e.g., an ambulance, a police car, a fire truck, etc.) that provides an emergency service and that is capable of emitting a periodic audio signal from a siren or the like that, when detected by an operator of a vehicle, for example, indicates to the vehicle operator 1) that the authority vehicle may be in proximity to the vehicle and 2) that measures may need to be taken to avoid a travel path of the authority vehicle. In addition, as used herein, an audio signal may refer to any acoustic signal originating from any source, whether inside a vehicle or external to a vehicle, that is detectable by an audio capture device such as a microphone. Further, as used herein, an audio signal stream refers to a stream of audio data received continuously over a period of time or on a periodic basis and which may include one or more audio signals originating from one or more signal sources and captured by one or more audio capture devices.

In example embodiments, an audio signal stream from an audio capture device provided on-board a vehicle can be analyzed to identify a known audio signature contained in the audio signal stream. An audio signal corresponding to the known audio signature can then be filtered from the audio signal stream to obtain a filtered audio signal stream output. In addition, in example embodiments, an audio signal that is below a threshold sound intensity value for at least a threshold period of time can also be filtered from the audio signal stream output to obtain the filtered output. Such an audio signal may be representative of background noise captured within the vehicle such as a conversation among occupants of the vehicle or a phone conversation involving an occupant of the vehicle. Moreover, in example embodiments, an audio signal that is above the threshold sound intensity value for less than a threshold period of time may also be filtered from the audio signal stream to obtain the filtered output. Such an audio signal may be representative of a loud noise that has a transient duration such as construction noise, a weather event (e.g., thunder), a vehicle collision, or the like.

It should be appreciated that, in certain example embodiments, multiple audio signal streams may be received from a collection of audio capture devices provided within a vehicle. For instance, multiple microphones may be disposed throughout an interior of a vehicle such that the microphones cumulatively provided a desired detectable audio coverage of the vehicle's interior environment. In example embodiments, the microphones or other audio capture devices located throughout an interior of a vehicle also have the capability to detect sounds above a certain sound intensity value within a certain radius of the vehicle. In this manner, an audio signal stream received from an audio capture device may include sounds generated and detected within a vehicle as well as sounds generated outside of the vehicle.

In some example embodiments, multiple audio signal streams may be aggregated or otherwise combined (e.g., interleaved) to form a composite signal stream that is further analyzed and filtered to remove audio signals such as those described above. In other example embodiments, the multiple audio signal streams may be separately analyzed and filtered to produce multiple filtered signal stream outputs. These multiple filtered signal stream outputs may then aggregated or otherwise combined to form a composite filtered output that is assessed to determine whether it is indicative of the presence of an authority vehicle in proximity to the vehicle.

In some example embodiments, a filtered signal stream output may be discarded prior to combining multiple filtered output streams if, for example, the filtered signal stream output exhibits beyond a threshold amount of signal attenuation, distortion, or loss. In some example embodiments, a respective weight may be applied to each of multiple filtered signal stream outputs prior to aggregation based, for example, on the strength of the audio signals contained therein, the amount of signal distortion, or the like. While example embodiments of the invention may be described herein in relation to scenarios involving the analysis and filtering of a single audio signal stream, it should be appreciated that the audio signal stream may be received from a single audio capture device or may be a composite stream formed from individual signal streams received from multiple audio capture devices.

In example embodiments, the filtered output can be analyzed to determine whether it is indicative of the presence of an authority vehicle in proximity to the vehicle. In example embodiments, an authority vehicle may be determined to be present in proximity to a vehicle if the authority vehicle is within a specified radius of the vehicle for a specified period of time. In some example embodiments, analyzing a filtered signal stream output to determine if it is indicative of the presence of an authority vehicle in proximity to a vehicle includes determining whether the filtered output includes an audio signal that satisfies certain criteria indicative of an authority vehicle.

In example embodiments, such criteria may include that the audio signal is above a threshold sound intensity value for at least a threshold period of time; that a frequency of the audio signal is within a predetermined range of frequencies for at least the threshold period of time; and/or that a periodicity of the audio signal is within a predetermined range of periodicities for at least the threshold period of time. In some example embodiments, an authority vehicle may be determined to be within a specified radius of a vehicle for a specified period of time based on the audio signal representative of the presence of the authority vehicle. For example, another vehicle may be determined to be present in proximity to a vehicle (e.g., within a certain radius of the vehicle for at least a certain period of time) if an audio signal contained in the filtered output signal stream is above a threshold sound intensity value for at least a threshold period of time, and the other vehicle may be determined to be an authority vehicle based on other characteristics of the audio signal such as its frequency and/or periodicity.

In example embodiments, if a filtered signal stream output is determined to contain an audio signal that is indicative of the presence of an authority vehicle in proximity of a vehicle, various vehicle response measures may be initiated. Such measures may include initiating a braking operation to bring an AV to a stop a predetermined distance from a travel path of the authority vehicle. Bringing the AV to a halt safely out of the travel path of the authority vehicle may include initiating other autonomous vehicle operations including, without limitation, a lane change operation, a deceleration operation, a vehicle turning operation, and so forth. Such vehicle response measures may further include turning on the vehicle's hazard lights and/or turn signal indicator to indicate that the vehicle is slowing down and coming to a stop. Such vehicle response measures may additionally include determining a modified navigation path for the AV. In certain example embodiments, the presence of an authority vehicle may be detected, but the authority vehicle may not yet be present within a defined proximity of the AV. In such example embodiments, the AV may determine a modified navigation route and may transition to the modified navigation route to prevent the authority vehicle from coming within the defined proximity of the AV.

In addition, in certain example embodiments, the response measure taken may include raising an alertness level for the AV such that additional measures may be taken to confirm or reject the presence of an authority vehicle in proximity to the vehicle. Such additional measures may include, for example, analyzing image data captured by one or more cameras of the AV to determine whether an authority vehicle is present in the image data. In certain example embodiments, determining whether an authority vehicle is present in the image data may include providing the image data to a neural network or other trained classifier configured to classify objects appearing in the image data.

Various embodiments of the invention overcome technical problems specifically arising in the realm of computer-based technology, and more specifically, in the realm of autonomous vehicle technology. In particular, example embodiments of the invention provide technical solutions to technical problems associated with autonomous vehicle technology as it relates to utilizing audio characteristics of a vehicle's environment to improve autonomous vehicle operation. More specifically, example embodiments of the invention provide a technical solution to the technical problem of detecting the presence of an authority vehicle in proximity to a vehicle and taking measures in response thereto in scenarios in which there is no vehicle operator to manually detect the sound of an authority vehicle siren such as in scenarios involving a driverless or autonomous vehicle.

Example embodiments of the invention include a number of technical features that provide the aforementioned technical solution. For instance, example embodiments of the invention include the technical feature of providing one or more audio capture devices such as microphones in an interior of a vehicle to capture audio signals from sources both inside and outside the vehicle. Example embodiments of the invention also include the technical feature of receiving an audio signal stream from such an audio capture device and filtering an audio signal corresponding to a known audio signature from the signal stream to obtain a filtered signal stream output. An audio signal corresponding to a known audio signature may be, for example, audio signals outputted from a speaker inside the vehicle (e.g., music being played, route guidance, etc.). Example embodiments of the invention also include the technical feature of filtering other signals from the input audio signal stream including signals representative of loud sounds that are not indicative of an authority vehicle (e.g., construction noise, vehicle collisions, etc.), signals representative of background noise present in the vehicle (e.g., a conversation involving a vehicle occupant), and so forth. Example embodiments of the invention further include the technical feature of assessing various characteristics of an audio signal present in the filtered signal stream output such as amplitude/intensity, frequency, and/or periodicity to determine whether the signal is indicative of the presence of an authority vehicle in proximity to the vehicle. Example embodiments of the invention still further include the technical feature of initiating various vehicle response measures in response to detection of the presence of an authority vehicle in proximity to the vehicle.

The aforementioned technical features individually and in combination provide a technical solution to the technical problem of detecting the presence of an authority vehicle and taking measures in response thereto in the absence of a human vehicle operator such as in autonomous vehicle scenarios. This technical solution constitutes a technological improvement that is necessarily rooted in computer-based autonomous vehicle technology.

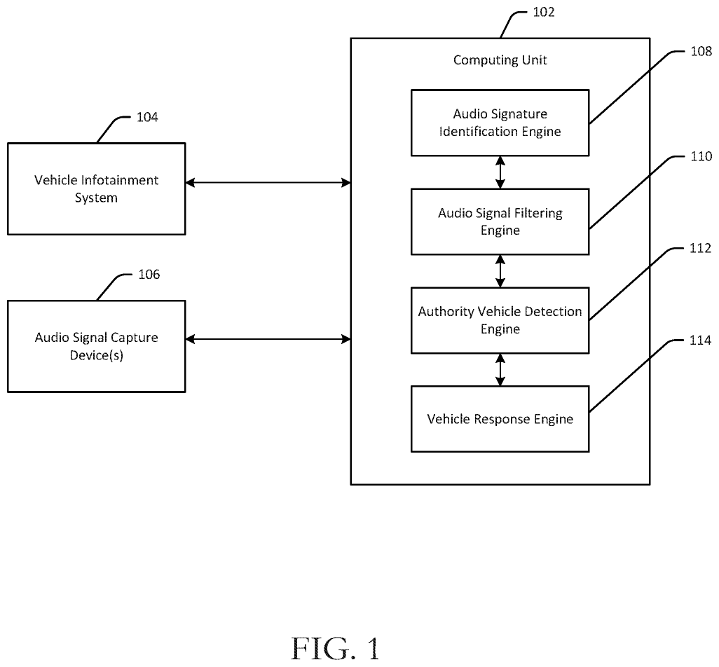

FIG. 1 is a schematic block diagram illustrating an example configuration of on-board vehicle components configured to implement automated authority vehicle detection in accordance with an example embodiment of the invention. In example embodiments, a vehicle may include an infotainment system 104. The vehicle infotainment system 104 may include any collection of hardware and software configured to provide audio and/or video content to occupants of a vehicle such as, for example, vehicle audio and/or video playback systems (e.g., cassette players, compact disc (CD) players, digital versatile disc (DVD) players, online content streaming devices, etc.); in-vehicle Universal Serial Bus (USB) connectivity; in-vehicle BLUETOOTH connectivity; in-vehicle WiFi/Internet connectivity; and so forth. The vehicle infotainment system 104 may be integrated with or otherwise communicatively coupled to one or more peripheral devices (not shown) such as a display, a speaker, dashboard knobs/controls, steering wheel controls, a microphone for receiving handsfree voice input, or the like.

In example embodiments, the vehicle infotainment system 104 may be communicatively coupled to an on-board computing unit 102. The vehicle may also include one or more audio signal capture devices 106 such as one or more microphones. In example embodiments, the audio signal capture devices 106 may be provided throughout an interior of the vehicle such that the devices 106 collectively provide a desired audio capture coverage for both sounds originating from within the vehicle as well as sounds originating outside the vehicle and having at least a threshold sound intensity/amplitude within a specified radius of the vehicle. In example embodiments, the audio capture devices 106 may be located at selected positions within the vehicle so as to minimize the amount of background noise within the vehicle or external background noise (e.g., road noise) that is detected by the devices 106. In example embodiments, the audio capture devices 106 may be communicatively coupled with the vehicle infotainment system 104 and the on-board computing unit 102.

The computing unit 102 may include hardware, firmware, and/or software configured to implement automated authority detection in accordance with example embodiments of the invention. The computing unit 102 may include one or more processing units (not shown) such as a microprocessor configured to execute computer-readable code/instructions, an integrated circuit, a specialized computing chip such as a field programmable gate array (FPGA) or an application-specific integrated circuit (ASIC), or the like. In example embodiments, the computing unit 102 may include various hardware and/or software engines such as an audio signature identification engine 108, an audio signal filtering engine 110, an authority vehicle detection engine 112, and a vehicle response engine 114. The computing unit 102 may receive one or more audio signal streams from the audio signal capture devices 106 and may utilize the various engines to analyze the input audio signal stream(s) and perform automated authority vehicle detection based thereon in accordance with example embodiments of the invention, as will be described in more detail hereinafter in reference to the other Figures.

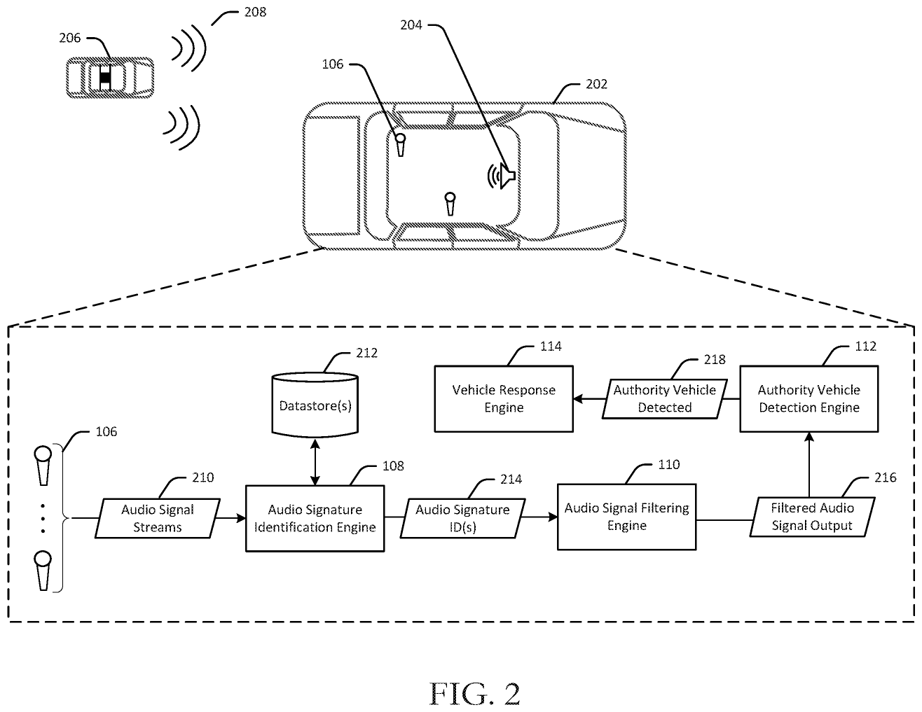

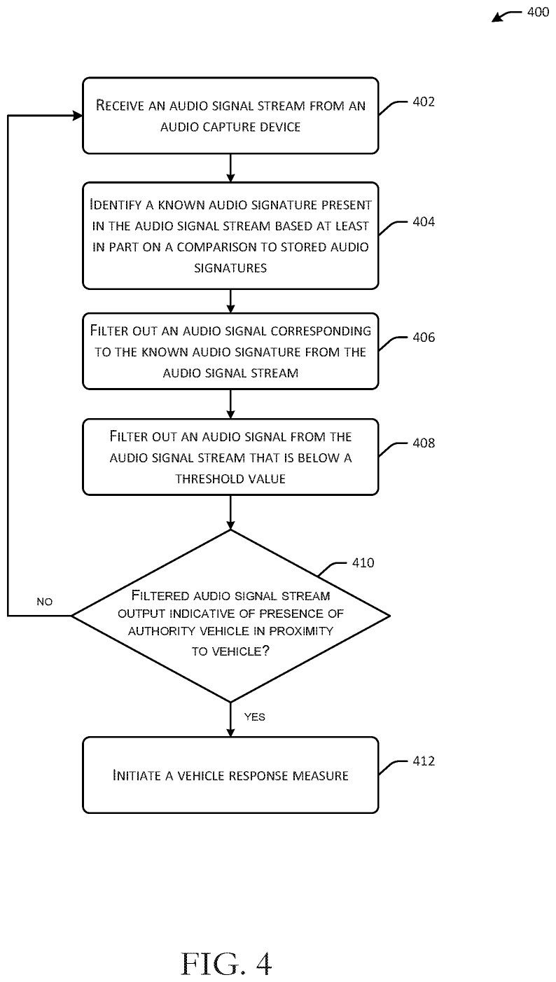

FIG. 2 is a schematic hybrid data flow and block diagram illustrating automated authority vehicle detection in accordance with an example embodiment of the invention. FIG. 4 is a process flow diagram of an illustrative method 400 for automated authority vehicle detection in accordance with an example embodiment of the invention. FIGS. 2 and 4 will be described in conjunction with one another hereinafter.

Each operation of the method 400 can be performed by one or more of the engines or the like depicted in FIG. 1, 2, or 5, whose operation will be described in more detail hereinafter. These engines can be implemented in any combination of hardware, software, and/or firmware. In certain example embodiments, one or more of these engines can be implemented, at least in part, as software and/or firmware modules that include computer-executable instructions that when executed by a processing circuit cause one or more operations to be performed. In example embodiments, these engines may be customized computer-executable logic implemented within a customized computing chip such as an FPGA or ASIC. A system or device described herein as being configured to implement example embodiments of the invention can include one or more processing circuits, each of which can include one or more processing units or cores. Computer-executable instructions can include computer-executable program code that when executed by a processing core can cause input data contained in or referenced by the computer-executable program code to be accessed and processed by the processing core to yield output data.

Referring first to FIG. 2, a vehicle 202 is depicted. The vehicle 202 may be an autonomous or driverless vehicle in some example embodiments. The vehicle 202 may include various embedded systems such as the vehicle infotainment system 104 depicted in FIG. 1. The vehicle infotainment system 104 may be integrated with or otherwise communicatively coupled to various peripheral devices including, for example, an audio output device such as a speaker 204. In some example embodiments, multiple speakers 204 may be provided throughout an interior of the vehicle 202.

In example embodiments, one or more audio capture devices 106 (e.g., microphones) may also be provided throughout an interior of the vehicle 202. The audio capture device(s) 106 may be configured to detect sounds originating from within the vehicle 202 (e.g., voice output from an occupant of the vehicle 202, audio output from a speaker 204 in the vehicle 202, etc.) as well as sounds originating outside the vehicle that are above a threshold sound intensity value and/or sounds originating outside the vehicle 202 that are within a certain radius of the vehicle 202. For instance, an audio capture device 106 may be able to detect audio signals 208 emitted from a siren of an authority vehicle 206. In example embodiments, an audio capture device 106 may be able to detect the audio signals 208 from the authority vehicle 206 over a larger radius from the vehicle 202 than a radius over which other external sounds may be detectable (e.g., road noise, music originating from another vehicle, etc.). It should be appreciated, however, that, in some example embodiments, there is a radius outside of which the audio signals 208 may not be detectable by an audio capture device 106 inside the vehicle 202. It should further be appreciated that, in some example embodiments, as the authority vehicle 206 enters a certain radius of the vehicle 202 and the audio signals 208 become detectable by an audio capture device 106 inside the vehicle 202, an amplitude/sound intensity level of the audio signals 208 may increase as the authority vehicle 206 comes into closer proximity to the vehicle 202.

Referring now to FIG. 4 in conjunction with FIG. 2, at block 402 of the method 400, an audio signal stream 210 may be received from an audio capture device 106 provided inside the vehicle 202. More specifically, the computing unit 102 may receive the audio signal stream 210 as input. While the example method 400 will be described in relation to a particular audio signal stream 210 received from a particular audio capture device 106, it should be appreciated that example embodiments encompass scenarios in which multiple signal streams are received from a collection of audio capture devices 106 in the vehicle 202. As previously noted, in such example embodiments, the multiple audio signal streams may be combined prior to analysis and filtering by the computing unit 102. Alternatively, the multiple audio signal streams may be individually analyzed and filtered and one or more of the filtered output streams may be combined and subsequently analyzed for the presence of an audio signal indicative of the authority vehicle 208 being in proximity to the vehicle 202.

At block 404 of the method 400, the audio signature identification engine 108 may identify a known audio signature present in the audio signal stream 210 based at least in part on a comparison to audio signatures stored in one or more datastores 212. In example embodiments, an audio signature may correspond to some portion of an audio signal that includes signal characteristics (e.g., frequency, periodicity, amplitude, etc.) that are representative of the audio signal and that serve to identify a source of the signal and distinguish that source from other signal sources. In example embodiments, a known audio signature may be identified from the audio signal stream 210 by extracting a respective audio signature from each audio signal identified in the audio signal stream 210 and comparing each such audio signature to known audio signatures stored in the datastore(s) 212. If a matching audio signature is located among the stored audio signatures, then the audio signature present in the audio signal stream 210 that corresponds to the matching stored audio signature is identified as a known audio signature.

In example embodiments, the datastore(s) 212 may have been populated with audio signatures extracted from audio signals detected by the audio capture devices 106 over period of time prior to receipt of the audio signal stream 210. In particular, prior to receipt of the audio signal stream 210, the audio capture devices 106 may have captured audio signals within the vehicle 202 and may have extracted and stored audio signatures corresponding thereto. As such, when the audio signal stream 210 is received, the signal stream 210 can be analyzed to determine whether it contains an audio signal having a corresponding audio signature that matches a previously stored audio signature, in which case, the audio signature of the audio signal contained in the signal stream 210 is identified as a known audio signature.

As a non-limiting example, prior to capture of the audio signal stream 210, one or more audio capture devices 106 in the vehicle 202 may detect an audio signal outputted by a speaker 204, identify and extract an audio signature from the audio signal, and store the audio signature in association with a corresponding identifier in the datastore(s) 212. As previously noted, the audio signature may be a snippet of the audio signal that serves to identify the audio signal and/or the source of the audio signal. Then, when the audio signal stream 210 is received and a stored audio signature that matches an audio signature of a signal contained in the signal stream 210 is identified, this may indicate that the same or at least a substantially similar audio signal was previously captured by an audio capture device 106 in the vehicle 202, and thus, that the signal is associated with a known audio signature. This, in turn, may indicate that the signal corresponding to the known audio signature is not indicative of a signal 208 that would be received from the authority vehicle 206, in which case, the signal corresponding to the known audio signature may be filtered out from the audio signal stream 210 at block 406 of the method 400.

More specifically, in example embodiments, the audio signature identification engine 108 may provide an identifier 214 of the matching audio signature as input to the audio signal filtering engine 110 which may, in turn, use the identifier 214 to locate and filter out the corresponding audio signal from the audio signal stream 210. In example embodiments, the audio signal filtering engine 110 may use a band-pass filter or the like to filter out a range of frequencies that includes the audio signal corresponding to the known audio signature.

In certain example embodiments, each audio signature stored in the datastore(s) 212 may contain enough data to exclude the possibility that a stored audio signature corresponds to an audio signal (e.g., audio signal 208) of the type that would typically be emitted by an authority vehicle (e.g., authority vehicle 206). More specifically, in some example embodiments, an audio signature may only be stored if it includes a portion of a corresponding audio signal (or some other representation thereof) over a period of time that exceeds the upper limit of the amount of time that an authority vehicle signal 208 (e.g., a siren) would be detectable by an audio capture device 106. In this manner, storing audio signatures corresponding to authority vehicle signals 208 detected prior to receipt of the audio signal stream can be avoided, and it can be ensured that no stored audio signatures correspond to an authority vehicle signal 208.

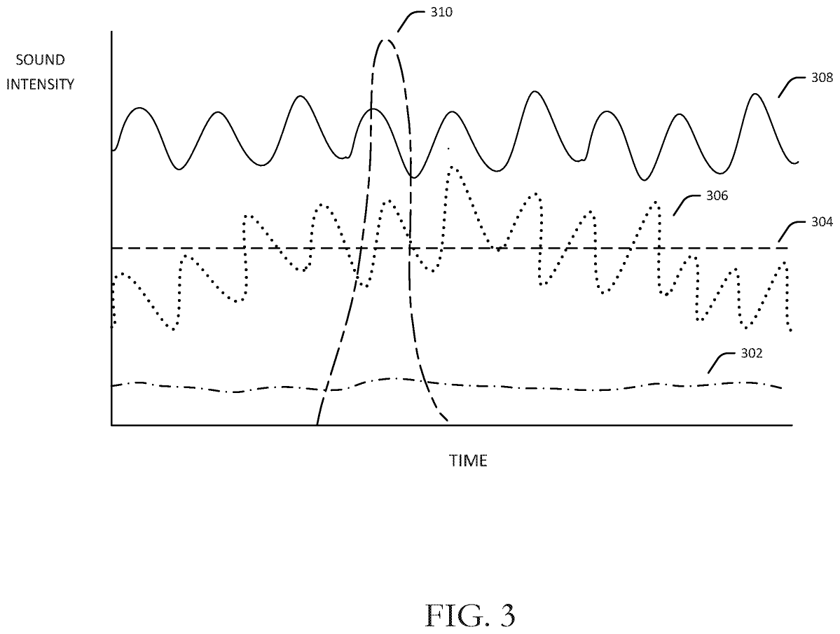

FIG. 3 illustrates various audio signals that may be present in the audio signal stream 210 in an example embodiment of the invention. As a non-limiting example, the audio signal stream 210 may include audio signals 302, 306, 308, and 310. In an example embodiment, the audio signal filtered from the audio signal stream 210 at block 406 of the method 400 may be audio signal 306. As depicted in FIG. 3, the audio signal 306 may have a periodicity associated therewith. For instance, if the audio signal 306 is representative of music being played from the speaker 204 of the vehicle 202, the music may have elements that repeat over time (e.g., a chorus) and/or elements that have similar tonal frequency characteristics (e.g., each verse). This often repetitive nature of music may be reflected in the periodicity of the audio signal 306. While the audio signal 306 may have a certain degree of periodicity associated therewith, the audio signal 306 may, at the same time, deviate from a completely sinusoidal curve. For instance, deviations in sound intensity, tonal frequencies, and the like—such as those that often occur in music—may cause the audio signal 306 to exhibit fluctuations in amplitude, frequency, and/or periodicity, which typically may not exceed certain bounded ranges.

Referring again to FIG. 4, at block 408 of the method 400, the audio signal filtering engine 110 may filter out an audio signal from the audio signal stream 210 that is below a threshold value. In example embodiments, the audio signal filtering engine 110 may apply a high pass filter to the audio signal stream 210 to filter out the signal at block 408 of the method 400. The audio signal filtered out at block 408 may be, for example, the audio signal 302 depicted in FIG. 3. In example embodiments, the audio signal 302 may be associated with low intensity background noise detected within the vehicle 202 such as conversations involving one or more occupants of the vehicle 202, low intensity audio output from the speaker 204 (e.g., music being played at a low volume), or other low intensity sounds originating from within the vehicle 202. In other example embodiments, the audio signal 302 may correspond to low level background noise originating from outside the vehicle 202 such as road noise, sounds originating from other vehicles, or other external sounds. As shown in FIG. 3, the audio signal 302 remains below the threshold value 304 for the duration of time over which the audio signal 302 is captured. However, it should be appreciated that, in some example embodiments, the amplitude (e.g., sound intensity) of the audio signal 302 may exceed the threshold value 304 for limited durations of time. Accordingly, in some example embodiments, the audio signal filtering engine 110 may first determine that the audio signal 302 is cumulatively below the threshold value 304 for at least a threshold period of time prior to filtering out the signal at block 408 of the method 400.

Further, although not depicted as part of the example method 400, in some example embodiments, the audio signal filtering engine 110 may also filter out other types of audio signals that are not likely to be indicative of an audio signal 208 emitted by the authority vehicle 206. For instance, in some example embodiments, the audio signal filtering engine 110 may filter out a signal such as audio signal 310 that exhibits a peak amplitude above the threshold value 304, but which remains above the threshold value 304 for only a limited duration. The audio signal 310 may be representative of a loud but transient noise originating from within the vehicle 202 (e.g., brief yelling or screaming by an occupant of the vehicle 202) or originating from outside the vehicle 202 (e.g., a loud construction noise, a vehicle collision, etc.). In example embodiments, the audio signal filtering engine 110 may determine that the audio signal 310 has an amplitude/sound intensity level above the threshold value 304 for less than a threshold period of time and may filter out the signal 310 from the audio signal stream 210 based on such a determination.

In example embodiments, after various audio signals have been filtered out from the audio signal stream 210 based on the evaluation of various criteria as described earlier, a filtered audio signal output 216 may be obtained. In example embodiments, the authority vehicle detection engine 112 may receive the filtered audio signal output 216 as input and may evaluate the filtered output 216 at block 410 of the method 400 to determine whether the filtered output 216 is indicative of the presence of the authority vehicle 206 within proximity of the vehicle 202.

In example embodiments, the authority vehicle detection engine 112 may determine that the authority vehicle 206 is present in proximity to the vehicle 202 if the authority vehicle 206 is within a specified radius of the vehicle for a specified period of time. In some example embodiments, the authority vehicle detection engine 112 may make this determination based at least in part on whether the filtered output 216 includes an audio signal that satisfies certain criteria indicative of an authority vehicle. In example embodiments, such criteria may include that the audio signal is above a threshold sound intensity value for at least a threshold period of time; that a frequency of the audio signal is within a predetermined range of frequencies for at least the threshold period of time; and/or that a periodicity of the audio signal is within a predetermined range of periodicities for at least the threshold period of time.

The audio signal 308 depicted in FIG. 3 may be an example signal that is indicative of the presence of the authority vehicle 206 in proximity to the vehicle 202. As shown in FIG. 3, the audio signal 308 exhibits a frequency pattern and a periodicity that stay within a narrow range of frequencies and periodicities, respectively, for the duration that the signal 308 is captured. In addition, the signal 308 is above the threshold value 304 for the duration of the signal 308. While the audio signal 308 is depicted in FIG. 3 as having an amplitude/sound intensity above the threshold sound intensity value 304 for the duration of the signal 308, it should be appreciated that an audio signal may still be indicative of the presence of the authority vehicle 206 even if the audio signal drops below the threshold value 304 as long as the audio signal is determined to be above the threshold value 304 for a cumulative period of time that meets or exceeds a threshold period of time and as long as the audio signal has other audio characteristics that satisfy criteria relating to signal frequency and/or signal periodicity.

Further, while the audio signal 308 is depicted as having a sound intensity above the threshold value 304 for the duration of the signal 308, it should be appreciated that the sound intensity of the audio signal 308 may initially be below the threshold value 304 and may increase to above the threshold value 304 as the authority vehicle 206 nears the vehicle 202, where it may remain while the authority vehicle 206 is within a certain radius of the vehicle 202. The sound intensity of the audio signal 308 may then begin to decrease as the authority vehicle 206 moves away from the vehicle 202, and may ultimately fall below the threshold value 304 when the authority vehicle 206 exceeds a certain radius from the vehicle 202. As such, in example embodiments, the authority vehicle detection engine 112 may determine that the audio signal 308 is indicative of a signal 208 of the type expected to be emitted from the authority vehicle 206 based on frequency and/or periodicity characteristics of the signal 308, but may determine presence of the authority vehicle 206 in proximity to the vehicle 202 based on the duration of time that the sound intensity value of the signal 308 is above the threshold value 304.

Referring again to FIG. 4, in example embodiments, in response to a negative determination at block 410, the method 400 may again proceed to block 402, where additional audio signal streams 210 may be received by the computing unit 102 for assessment. On the other hand, in response to a positive determination at block 410, an indication 218 that the authority vehicle 206 has been detected in proximity to the vehicle 202 may be sent to the vehicle response engine 114. Then, at block 412 of the method 400, the vehicle response engine 114 may initiate a vehicle response measure in response to detection of the presence of the authority vehicle 206. The vehicle response measure initiated by the vehicle response engine 114 may be an automated braking operation to bring the vehicle 202 (which as previously noted may be an AV) to a stop a predetermined distance from a travel path of the authority vehicle 206. Bringing the vehicle 202 to a halt safely out of the travel path of the authority vehicle 206 may include initiating other autonomous vehicle operations including, without limitation, a lane change operation, a deceleration operation, a vehicle turning operation, and so forth.

The vehicle response measures initiated at block 412 may further include turning on the vehicle's 202 hazard lights and/or turn signal indicator to indicate that the vehicle 202 is slowing down and coming to a stop, determining a modified navigation path for the vehicle 202, or the like. In certain example embodiments, the presence of the authority vehicle 206 may be detected, but the authority vehicle 206 may not yet be present within a defined proximity of the vehicle 202. In such example embodiments, the computing unit 102 or another system of the vehicle 202 (e.g., a navigation unit) may determine a modified navigation route for the vehicle 202 and may transition the vehicle 202 to the modified navigation route to prevent the authority vehicle 206 from coming within the defined proximity of the vehicle 202.

While the example method 400 has been described in relation to a particular audio signal stream 210, it should be appreciated that, in certain example embodiments, multiple audio signal streams 210 may be received from a collection of audio capture devices 106 in the vehicle 202. In some example embodiments, multiple audio signal streams 210 may be aggregated or otherwise combined (e.g., interleaved) to form a composite signal stream that is further analyzed and filtered to remove audio signals such as those described above. In other example embodiments, the multiple audio signal 210 streams may be separately analyzed and filtered to produce multiple filtered signal stream outputs 216. These multiple filtered signal stream outputs 216 may then aggregated or otherwise combined to form a composite filtered output that is assessed to determine whether it is indicative of the presence of the authority vehicle 206 in proximity to the vehicle 202.

In some example embodiments, a filtered signal stream output may be discarded prior to combining multiple filtered output streams if, for example, the filtered signal stream output exhibits beyond a threshold amount of signal attenuation, distortion, or loss. In some example embodiments, a respective weight may be applied to each of multiple filtered signal stream outputs prior to aggregation based, for example, on the strength of the audio signals contained therein, the amount of signal distortion, or the like. While example embodiments of the invention may be described herein in relation to scenarios involving the analysis and filtering of a single audio signal stream 210, it should be appreciated that the audio signal stream 210 may be received from a single audio capture device 106 or may be a composite stream formed from individual signal streams received from multiple audio capture devices 106.

### Hardware Implementation

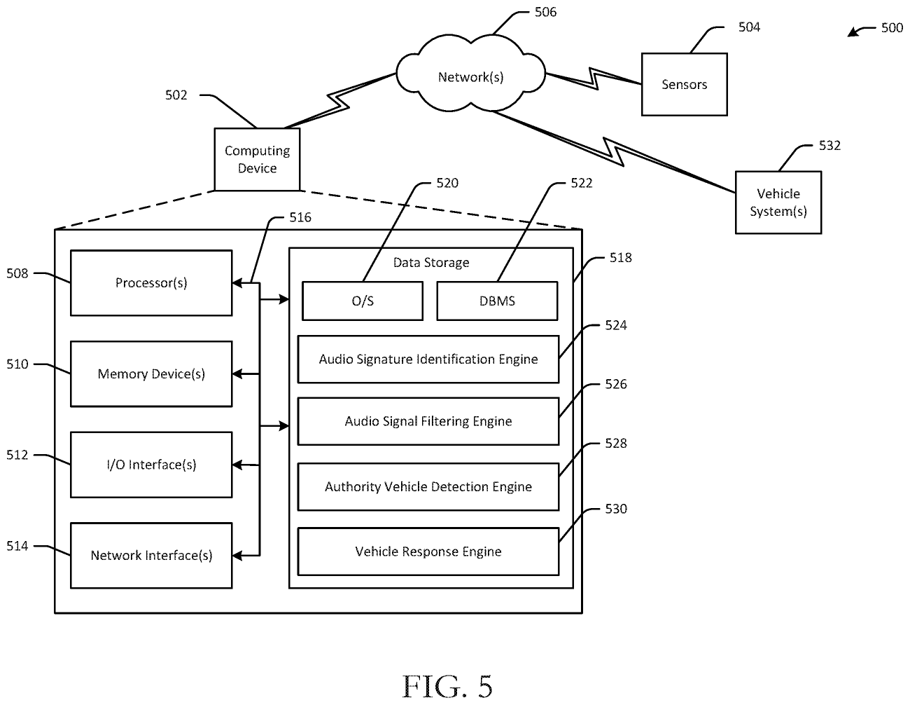

FIG. 5 is a schematic block diagram illustrating an example networked architecture 500 configured to implement example embodiments of the invention. The networked architecture 500 can include one or more special-purpose computing devices 502 communicatively coupled via one or more networks 506 to various sensors 504. The sensors 504 may include any of the example types of on-board vehicle sensors previously described including, without limitation, microphones, LiDAR sensors, radars, cameras, GPS receivers, sonar-based sensors, ultrasonic sensors, IMUs, accelerometers, gyroscopes, magnetometers, FIR sensors, and so forth. In example embodiments, the sensors 504 may include on-board sensors provided on an exterior or in an interior of a vehicle such as an autonomous vehicle. However, in certain example embodiments, the sensors 504 may also include one or more fixed sensors provided in a physical environment surrounding a vehicle. The special-purpose computing device(s) 502 may include devices that are integrated with a vehicle and may receive sensor data from the sensors 504 via a local network connection (e.g., WiFi, Bluetooth, Dedicated Short Range Communication (DSRC), or the like). In other example embodiments, the special-purpose computing device(s) 502 may be provided remotely from a vehicle and may receive the sensor data from the sensors 504 via one or more long-range networks.

The special-purpose computing device(s) 502 may also be communicatively coupled to one or more vehicle systems 532 via the network(s) 506. The vehicle system(s) 532 may include, for example, the vehicle infotainment system 104 (FIG. 1), a vehicle navigation system, or any other system integrated with or otherwise in communication with a vehicle.

The special-purpose computing device(s) 502 may be hard-wired to perform the techniques described herein; may include circuitry or digital electronic devices such as one or more ASICs or FPGAs that are persistently programmed to perform the techniques; and/or may include one or more hardware processors programmed to perform the techniques pursuant to program instructions in firmware, memory, other storage, or a combination thereof. The special-purpose computing device(s) 502 may also combine custom hard-wired logic, ASICs, or FPGAs with custom programming to accomplish the techniques. The special-purpose computing device(s) 502 may be desktop computer systems, server computer systems, portable computer systems, handheld devices, networking devices or any other device or combination of devices that incorporate hard-wired and/or programmed logic to implement the techniques. In example embodiments, the computing unit 102 may form part of the special-purpose computing device(s) 502.

The special-purpose computing device(s) may be generally controlled and coordinated by operating system software 520, such as iOS, Android, Chrome OS, Windows XP, Windows Vista, Windows 7, Windows 8, Windows Server, Windows CE, Unix, Linux, SunOS, Solaris, iOS, Blackberry OS, VxWorks, or other compatible operating systems. In other embodiments, the computing device(s) 502 may be controlled by a proprietary operating system. The operating system software 520 may control and schedule computer processes for execution; perform memory management; provide file system, networking, and I/O services; and provide user interface functionality, such as a graphical user interface (“GUI”).

While the computing device(s) 502, the vehicle system(s) 532, and/or the sensors 504 may be described herein in the singular, it should be appreciated that multiple instances of any such component can be provided and functionality described in connection any particular component can be distributed across multiple instances of such a component. In certain example embodiments, functionality described herein in connection with any given component of the architecture 500 can be distributed among multiple components of the architecture 500. For example, at least a portion of functionality described as being provided by a computing device 502 may be distributed among multiple such computing devices 502.

The network(s) 506 can include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. The network(s) 506 can have any suitable communication range associated therewith and can include, for example, global networks (e.g., the Internet), metropolitan area networks (MANs), wide area networks (WANs), local area networks (LANs), or personal area networks (PANs). In addition, the network(s) 506 can include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computing device 502 can include one or more processors (processor(s)) 508, one or more memory devices 510 (generically referred to herein as memory 510), one or more input/output (“I/O”) interface(s) 512, one or more network interfaces 514, and data storage 518. The computing device 502 can further include one or more buses 516 that functionally couple various components of the computing device 502. The computing device 502 may also include various program modules/engines such as an audio signature identification engine 524, an audio signal filtering engine 526, an authority vehicle detection engine 528, and a vehicle response engine 530. These engines may be implemented in any combination of software, hardware, or firmware. While these engines are illustratively depicted as software/firmware modules stored in the data storage 518, it should be appreciated that the engines may include hard-wired logic, customized logic of a persistently programmed customized computing device such as an ASIC or FPGA, or the like. Each of the engines may include logic for performing any of the processes and tasks described earlier in connection with correspondingly named engines depicted in FIGS. 1 and 2.

The bus(es) 516 can include at least one of a system bus, a memory bus, an address bus, or a message bus, and can permit the exchange of information (e.g., data (including computer-executable code), signaling, etc.) between various components of the computing device 502. The bus(es) 516 can include, without limitation, a memory bus or a memory controller, a peripheral bus, an accelerated graphics port, and so forth. The bus(es) 516 can be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 510 can include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, can include non-volatile memory. In certain example embodiments, volatile memory can enable faster read/write access than non-volatile memory. However, in certain other example embodiments, certain types of non-volatile memory (e.g., FRAM) can enable faster read/write access than certain types of volatile memory.

In various implementations, the memory 510 can include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 510 can include main memory as well as various forms of cache memory such as instruction cache(s), data cache(s), translation lookaside buffer(s) (TLBs), and so forth. Further, cache memory such as a data cache can be a multi-level cache organized as a hierarchy of one or more cache levels (L1, L2, etc.).

The data storage 518 can include removable storage and/or non-removable storage including, but not limited to, magnetic storage, optical disk storage, and/or tape storage. The data storage 518 can provide non-volatile storage of computer-executable instructions and other data. The memory 510 and the data storage 518, removable and/or non-removable, are examples of computer-readable storage media (CRSM) as that term is used herein. The data storage 518 can store computer-executable code, instructions, or the like that can be loadable into the memory 510 and executable by the processor(s) 508 to cause the processor(s) 508 to perform or initiate various operations. The data storage 518 can additionally store data that can be copied to memory 510 for use by the processor(s) 508 during the execution of the computer-executable instructions. Moreover, output data generated as a result of execution of the computer-executable instructions by the processor(s) 508 can be stored initially in memory 510 and can ultimately be copied to data storage 518 for non-volatile storage.

More specifically, the data storage 518 can store one or more operating systems (O/S) 520 and one or more database management systems (DBMS) 522 configured to access the memory 510 and/or one or more external datastore(s) (the datastore(s) 212 depicted in FIG. 2) potentially via one or more of the networks 506. In addition, the data storage 518 may further store one or more program modules, applications, engines, computer-executable code, scripts, or the like. For instance, any of the program modules described herein may be implemented as software and/or firmware that includes computer-executable instructions (e.g., computer-executable program code) loadable into the memory 510 for execution by one or more of the processor(s) 508 to perform any of the techniques described herein.

Although not depicted in FIG. 5, the data storage 518 can further store various types of data utilized by program modules of the computing device 502. Such data may include, without limitation, sensor data (e.g., audio data); audio signature data; threshold values; and so forth. Any data stored in the data storage 518 can be loaded into the memory 510 for use by the processor(s) 508 in executing computer-executable program code. In addition, any data stored in the data storage 518 can potentially be stored in one or more external datastores that are accessible via the DBMS 522 and loadable into the memory 510 for use by the processor(s) 508 in executing computer-executable instructions/program code.

The processor(s) 508 can be configured to access the memory 510 and execute computer-executable instructions/program code loaded therein. For example, the processor(s) 508 can be configured to execute computer-executable instructions/program code of the various program modules to cause or facilitate various operations to be performed in accordance with one or more embodiments of the invention. The processor(s) 508 can include any suitable processing unit capable of accepting data as input, processing the input data in accordance with stored computer-executable instructions, and generating output data. The processor(s) 508 can include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 508 can have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 508 can be made capable of supporting any of a variety of instruction sets.

Referring now to other illustrative components depicted as being stored in the data storage 518, the 0/S 520 can be loaded from the data storage 518 into the memory 510 and can provide an interface between other application software executing on the computing device 502 and hardware resources of the computing device 502. More specifically, the 0/S 520 can include a set of computer-executable instructions for managing hardware resources of the computing device 502 and for providing common services to other application programs. In certain example embodiments, the 0/S 520 can include or otherwise control execution of one or more of the program modules stored in the data storage 518. The O/S 520 can include any operating system now known or which can be developed in the future including, but not limited to, any server operating system, any mainframe operating system, or any other proprietary or non-proprietary operating system.

The DBMS 522 can be loaded into the memory 510 and can support functionality for accessing, retrieving, storing, and/or manipulating data stored in the memory 510, data stored in the data storage 518, and/or data stored in external datastore(s). The DBMS 522 can use any of a variety of database models (e.g., relational model, object model, etc.) and can support any of a variety of query languages. The DBMS 522 can access data represented in one or more data schemas and stored in any suitable data repository. Datastore(s) that may be accessible by the computing device 502 via the DBMS 522, can include, but are not limited to, databases (e.g., relational, object-oriented, etc.), file systems, flat files, distributed datastores in which data is stored on more than one node of a computer network, peer-to-peer network datastores, or the like.

Referring now to other illustrative components of the computing device 502, the input/output (I/O) interface(s) 512 can facilitate the receipt of input information by the computing device 502 from one or more I/O devices as well as the output of information from the computing device 502 to the one or more I/O devices. The I/O devices can include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components can be integrated into the computing device 502 or can be separate therefrom. The I/O devices can further include, for example, any number of peripheral devices such as data storage devices, printing devices, and so forth.

The I/O interface(s) 512 can also include an interface for an external peripheral device connection such as universal serial bus (USB), FireWire, Thunderbolt, Ethernet port or other connection protocol that can connect to one or more networks. The I/O interface(s) 512 can also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The computing device 502 can further include one or more network interfaces 514 via which the computing device 502 can communicate with any of a variety of other systems, platforms, networks, devices, and so forth. The network interface(s) 514 can enable communication, for example, with the sensors 504 and/or the vehicle system(s) 532 via one or more of the network(s) 506. In example embodiments, the network interface(s) 514 provide a two-way data communication coupling to one or more network links that are connected to one or more of the network(s) 506. For example, the network interface(s) 514 may include an integrated services digital network (ISDN) card, a cable modem, a satellite modem, or a modem to provide a data communication connection to a corresponding type of telephone line. As another non-limiting example, the network interface(s) 514 may include a local area network (LAN) card to provide a data communication connection to a compatible LAN (or a wide area network (WAN) component to communicate with a WAN). Wireless links may also be implemented. In any such implementation, the network interface(s) 514 may send and receive electrical, electromagnetic, or optical signals that carry digital data streams representing various types of information.

A network link typically provides data communication through one or more networks to other data devices. For example, a network link may provide a connection through a local network to a host computer or to data equipment operated by an Internet Service Provider (ISP). The ISP, in turn, may provide data communication services through the world wide packet data communication network now commonly referred to as the “Internet”. Local networks and the Internet both use electrical, electromagnetic, or optical signals that carry digital data streams. The signals through the various network(s) 504 and the signals on network links and through the network interface(s) 514, which carry the digital data to and from the computing device 502, are example forms of transmission media. In example embodiments, the computing device 502 can send messages and receive data, including program code, through the network(s) 506, network links, and network interface(s) 514. For instance, in the Internet example, a server might transmit a requested code for an application program through the Internet, the ISP, a local network, and a network interface 514. The received code may be executed by a processor 508 as it is received, and/or stored in the data storage 518, or other non-volatile storage for later execution.

It should be appreciated that the engines depicted in FIG. 5 as part of the computing device 502 are merely illustrative and not exhaustive and that processing described as being supported by any particular engine/component can alternatively be distributed across multiple engines, components, modules, or the like, or performed by a different engine, component, module, or the like. In addition, various program module(s), engine(s), script(s), plug-in(s), Application Programming Interface(s) (API(s)), or any other suitable computer-executable code hosted locally on the computing device 502 and/or hosted on other computing device(s) (e.g., a sensor 504) accessible via one or more of the network(s) 506, can be provided to support functionality provided by the engines/components depicted in FIG. 5 and/or additional or alternate functionality. Further, functionality can be modularized in any suitable manner such that processing described as being performed by a particular engine can be performed by a collection of any number of engines, components, program modules, or the like, or functionality described as being supported by any particular engine can be supported, at least in part, by another engine, component, or program module. In addition, engines that support functionality described herein can be executable across any number of computing devices 502 in accordance with any suitable computing model such as, for example, a client-server model, a peer-to-peer model, and so forth. In addition, any of the functionality described as being supported by any of the engines depicted in FIG. 5 can be implemented, at least partially, in hardware and/or firmware across any number of devices or servers.

It should further be appreciated that the computing device 502 can include alternate and/or additional hardware, software, or firmware components beyond those described or depicted without departing from the scope of the invention. More particularly, it should be appreciated that software, firmware, or hardware components depicted as forming part of the computing device 502 are merely illustrative and that some components may or may not be present or additional components can be provided in various embodiments. It should further be appreciated that each of the above-mentioned engines represent, in various embodiments, a logical partitioning of supported functionality. This logical partitioning is depicted for ease of explanation of the functionality and may or may not be representative of the structure of software, hardware, and/or firmware for implementing the functionality. Accordingly, it should be appreciated that functionality described as being provided by a particular engine can, in various embodiments, be provided at least in part by one or more other engines, components, or program modules. Further, one or more depicted engines may or may not be present in certain embodiments, while in other embodiments, additional engines not depicted can be present and can support at least a portion of the described functionality and/or additional functionality.

In general, the terms program module or engine or the like, as used herein, refer to logic embodied in hardware or firmware, or to a collection of software instructions, possibly having entry and exit points, written in a programming language, such as, for example, Java, C or C++. A software engine/module may be compiled and linked into an executable program, installed in a dynamic link library, or may be written in an interpreted programming language such as, for example, BASIC, Perl, or Python. It will be appreciated that software engines/modules may be callable from other engines/modules or from themselves, and/or may be invoked in response to detected events or interrupts. Software engines/modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors.

It will be appreciated that an “engine,” “program module,” “system,” “datastore,” and/or “database” may comprise software, hardware, firmware, and/or circuitry. In one example, one or more software programs comprising instructions capable of being executable by a processor may perform one or more of the functions of the engines, data stores, databases, or systems described herein. In another example, circuitry may perform the same or similar functions. Alternative embodiments may comprise more, less, or functionally equivalent engines, systems, data stores, or databases, and still be within the scope of present embodiments. For example, the functionality of the various systems, engines, data stores, and/or databases may be combined or divided differently.

“Open source” software is defined herein to be source code that allows distribution as source code as well as compiled form, with a well-publicized and indexed means of obtaining the source, optionally with a license that allows modifications and derived works.

Example embodiments are described herein as including logic or a number of program modules. Program modules may constitute either software engines (e.g., code embodied on a machine-readable medium) or hardware engines. A “hardware engine” is a tangible unit capable of performing certain operations and may be configured or arranged in a certain physical manner. In various example embodiments, one or more computer systems (e.g., a standalone computer system, a client computer system, or a server computer system) or one or more hardware engines of a computer system (e.g., a processor or a group of processors) may be configured by software (e.g., an application or application portion) as a hardware engine that operates to perform certain operations as described herein.

In some embodiments, a hardware engine may be implemented mechanically, electronically, or any suitable combination thereof. For example, a hardware engine may include dedicated circuitry or logic that is permanently configured to perform certain operations. For example, a hardware engine may be a special-purpose processor, such as a Field-Programmable Gate Array (FPGA) or an Application Specific Integrated Circuit (ASIC). A hardware engine may also include programmable logic or circuitry that is temporarily configured by software to perform certain operations. For example, a hardware engine may include software executed by a general-purpose processor or other programmable processor. Once configured by such software, hardware engines become specific machines (or specific components of a machine) uniquely tailored to perform the configured functions and are no longer general-purpose processors. It will be appreciated that the decision to implement a hardware engine mechanically, in dedicated and permanently configured circuitry, or in temporarily configured circuitry (e.g., configured by software) may be driven by cost and time considerations.

Accordingly, the terms “program module” or “engine” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware engines are temporarily configured (e.g., programmed), each of the hardware engines need not be configured or instantiated at any one instance in time. For example, where a hardware engine comprises a general-purpose processor configured by software to become a special-purpose processor, the general-purpose processor may be configured as respectively different special-purpose processors (e.g., comprising different hardware engines) at different times. Software accordingly configures a particular processor or processors, for example, to constitute a particular hardware engine at one instance of time and to constitute a different hardware engine at a different instance of time.

Hardware engines can provide information to, and receive information from, other hardware engines. Accordingly, the described hardware engines may be regarded as being communicatively coupled. Where multiple hardware engines exist contemporaneously, communications may be achieved through signal transmission (e.g., over appropriate circuits and buses) between or among two or more of the hardware engines. In embodiments in which multiple hardware engines are configured or instantiated at different times, communications between such hardware engines may be achieved, for example, through the storage and retrieval of information in memory structures to which the multiple hardware engines have access. For example, one hardware engine may perform an operation and store the output of that operation in a memory device to which it is communicatively coupled. A further hardware engine may then, at a later time, access the memory device to retrieve and process the stored output. Hardware engines may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein. As used herein, “processor-implemented engine” refers to a hardware engine implemented using one or more processors.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

The present invention may be implemented as a system, a method, and/or a computer program product. The computer program product may include a computer readable storage medium (or media) having computer readable program instructions embodied thereon for causing a processor to carry out aspects of the present invention.

The computer readable storage medium is a form of non-transitory media, as that term is used herein, and can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. The computer readable storage medium, and non-transitory media more generally, may comprise non-volatile media and/or volatile media. A non-exhaustive list of more specific examples of the computer readable storage medium includes the following: a portable computer diskette such as a floppy disk or a flexible disk; a hard disk; a random access memory (RAM), a read-only memory (ROM), an erasable programmable read-only memory (EPROM or Flash memory), a static random access memory (SRAM), or any other memory chip or cartridge; a portable compact disc read-only memory (CD-ROM); a digital versatile disk (DVD); a memory stick; a solid state drive; magnetic tape or any other magnetic data storage medium; a mechanically encoded device such as punch-cards or raised structures in a groove having instructions recorded thereon or any physical medium with patterns of holes; any networked versions of the same; and any suitable combination of the foregoing.

Non-transitory media is distinct from with transmission media, and thus, a computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Non-transitory, however, can operate in conjunction with transmission media. In particular, transmission media participates in transferring information between non-transitory media. For example, transmission media includes coaxial cables, copper wire and fiber optics, including the wires that comprise at least some of the bus(es) 516. Transmission media can also take the form of acoustic or light waves, such as those generated during radio-wave and infra-red data communications.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed partially, substantially, or entirely concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Although the invention(s) have been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The foregoing description of the present invention(s) have been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

As used herein, the term “or” may be construed in either an inclusive or exclusive sense. Moreover, plural instances may be provided for resources, operations, or structures described herein as a single instance. Additionally, boundaries between various resources, operations, engines, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

1. A computer-implemented method for automated detection of an authority vehicle, comprising:
receiving an audio signal stream from an audio capture device associated with a vehicle in motion;
identifying a first audio signal present in the audio signal stream, the first audio signal having a corresponding audio signature;
determining that the audio signature of the first audio signal matches a known audio signature;
identifying a second audio signal present in the first filtered audio signal stream;
determining that the second audio signal is below a threshold sound intensity value for a first threshold period of time;
identifying a third audio signal present in the second filtered audio signal stream;
determining that the third audio signal is above a threshold sound intensity value for less than a second threshold period of time;
performing one or more filtering steps to filter out the first audio signal, the second audio signal, and the third audio signal from the audio signal stream to obtain a filtered audio signal stream output; and
determining that the filtered audio signal stream output is indicative of presence of the authority vehicle in proximity to the vehicle.

2. The computer-implemented method of claim 1, wherein identifying the audio signature present in the audio signal stream as a known audio signature comprises determining that the audio signature matches one of a set of stored known audio signatures.

3. The computer-implemented method of claim 2, wherein the audio signal stream is a first audio signal stream, the method further comprising identifying the known audio signature matching the audio signature present in the first audio signal stream at least in part by analyzing a second audio signal stream received from the audio capture device prior to the first audio signal stream and extracting the known audio signature from the second audio signal stream.

4.-5. (canceled)

6. The computer-implemented method of claim 1, wherein determining that the filtered audio signal stream output is indicative of presence of the authority vehicle in proximity to the vehicle comprises at least one of:
determining that the filtered audio signal stream output includes an audio signal that is above a threshold sound intensity value for at least a threshold period of time;
determining that a frequency of the audio signal is within a predetermined range of frequencies for at least the threshold period of time; or
determining that a periodicity of the audio signal is within a predetermined range of periodicities for at least the threshold period of time.

7. The computer-implemented method of claim 1, further comprising initiating a vehicle response measure comprising an automated braking operation to bring the vehicle to a halt at least a predetermined distance from a travel path of the authority vehicle.

8. The computer-implemented method of claim 1, wherein the audio capture device is a microphone located within an interior of the vehicle.

9. The computer-implemented method of claim 1, wherein the vehicle is an autonomous vehicle.

10. A system for automated detection of an authority vehicle, comprising:
at least one processor; and
at least one memory storing computer-executable instructions, wherein the at least one processor is configured to access the at least one processor and execute the computer-executable instructions to:
receive an audio signal stream from an audio capture device associated with a vehicle in motion;
identify a first audio signal present in the audio signal stream, the first audio signal having a corresponding audio signature;
determine that the audio signature of the first audio signal matches a known audio signature;
identify a second audio signal present in the first filtered audio signal stream;
determine that the second audio signal is below a threshold sound intensity value for a first threshold period of time;
identify a third audio signal present in the second filtered audio signal stream;
determine that the third audio signal is above a threshold sound intensity value for less than a second threshold period of time;
perform one or more filtering steps to filter out the first audio signal, the second audio signal, and the third audio signal from the audio signal stream to obtain a filtered audio signal stream output; and
determine that the filtered audio signal stream output is indicative of presence of the authority vehicle in proximity to the vehicle.

11. The system of claim 10, wherein the at least one processor is configured to identify the audio signature present in the audio signal stream as a known audio signature by executing the computer-executable instructions to determine that the audio signature matches one of a set of stored known audio signatures.

12. The system of claim 11, wherein the audio signal stream is a first audio signal stream, and wherein the at least one processor is further configured to execute the computer-executable instructions to identify the known audio signature matching the audio signature present in the first audio signal stream at least in part by analyzing a second audio signal stream received from the audio capture device prior to the first audio signal stream and extracting the known audio signature from the second audio signal stream.

13.-14. (canceled)

15. The system of claim 10, wherein the at least one processor is configured to determine that the filtered audio signal stream output is indicative of presence of the authority vehicle in proximity to the vehicle by executing the computer-executable instructions to at least one of:
determine that the filtered audio signal stream output includes an audio signal that is above a threshold sound intensity value for at least a threshold period of time;
determine that a frequency of the audio signal is within a predetermined range of frequencies for at least the threshold period of time; or
determine that a periodicity of the audio signal is within a predetermined range of periodicities for at least the threshold period of time.

16. The system of claim 10, wherein the at least one processor is further configured to execute the computer-executable instructions to initiate a vehicle response measure comprising an automated braking operation to bring the vehicle to a halt at least a predetermined distance from a travel path of the authority vehicle.

17. The system of claim 10, wherein the audio capture device is a microphone located within an interior of the vehicle.

18. A computer program product for automated detection of an authority vehicle, the computer program product comprising a non-transitory computer-readable medium readable by a processing circuit, the non-transitory computer-readable medium storing instructions executable by the processing circuit to cause a method to be performed, the method comprising:
receiving an audio signal stream from an audio capture device associated with a vehicle in motion;
identifying a first audio signal present in the audio signal stream the first audio signal having a corresponding audio signature;
determining that the audio signature of the first audio signal matches a known audio signature;
identifying a second audio signal present in the first filtered audio signal stream;
determining that the second audio signal is below a threshold sound intensity value for a first threshold period of time;
identifying a third audio signal present in the second filtered audio signal stream;
determining that the third audio signal is above a threshold sound intensity value for less than a second threshold period of time;
performing one or more filtering steps to filter out the first audio signal, the second audio signal, and the third audio signal from the audio signal stream to obtain a filtered audio signal stream output; and
determining that the filtered audio signal stream output is indicative of presence of the authority vehicle in proximity to the vehicle.

19. The computer program product of claim 18, wherein the audio signal stream is a first audio signal stream, and wherein identifying the audio signature present in the first audio signal stream as a known audio signature comprises determining that the audio signature matches one of a set of stored known audio signatures, the method further comprising identifying the known audio signature matching the audio signature present in the first audio signal stream at least in part by analyzing a second audio signal stream received from the audio capture device prior to the first audio signal stream and extracting the known audio signature from the second audio signal stream.

20. The computer program product of claim 18, wherein determining that the filtered audio signal stream output is indicative of presence of the authority vehicle in proximity to the vehicle comprises at least one of:
determining that the filtered audio signal stream output includes an audio signal that is above a threshold sound intensity value for at least a threshold period of time;
determining that a frequency of the audio signal is within a predetermined range of frequencies for at least the threshold period of time; or
determining that a periodicity of the audio signal is within a predetermined range of periodicities for at least the threshold period of time.

21. The computer-implemented method of claim 3, wherein extracting the known audio signature from the second audio signal stream comprises selecting a portion of the second audio signal stream having a duration that exceeds an upper limit of an amount of time a signal emitted by the authority vehicle is detectable by the audio capture device.

22. The computer-implemented method of claim 1, further comprising aggregating the filtered audio signal stream output with one or more other filtered audio signal stream outputs to obtain a composite filtered audio signal stream output, and wherein determining that the filtered audio signal stream output is indicative of presence of the authority vehicle in proximity to the vehicle comprises determining that the composite filtered audio signal stream output is indicative of presence of the authority vehicle in proximity to the vehicle.

23. The system of claim 12, wherein the at least one processor is configured to extract the known audio signature from the second audio signal stream by executing the computer-executable instructions to select a portion of the second audio signal stream having a duration that exceeds an upper limit of an amount of time a signal emitted by the authority vehicle is detectable by the audio capture device.

24. The system of claim 10, wherein the at least one processor is further configured to execute the computer-executable instructions to aggregate the filtered audio signal stream output with one or more other filtered audio signal stream outputs to obtain a composite filtered audio signal stream output, and wherein the at least one processor is configured to determine that the filtered audio signal stream output is indicative of presence of the authority vehicle in proximity to the vehicle by executing the computer-executable instructions to determine that the composite filtered audio signal stream output is indicative of presence of the authority vehicle in proximity to the vehicle.
